(19) United States
(12) Patent Application Publication
(10) Pub. No.: US 2003/0007139 A1
(43) Pub. Date: Jan. 9, 2003

(54) Aligner

(76) Inventors: Katsumi Momose, Tokyo (JP); Gunji Mizutani, Tokyo (JP); Wataru Nakagawa, Tokyo (JP); Masatoshi Asami, (US); Kumuthini Kugamoorthy, Tokyo (JP)

Correspondence Address: Kevin S. Lemack, Nields & Lemack, 176 E. Main Street, Westboro, MA, 01581, US

(21) Appl. No.: 10/175,484

(22) Filed: Jun. 19, 2002

(30) Foreign Application Priority Data
Jul. 6, 2001 (JP) 2001-205812

(51) Int. Cl. G03B 27/58

(52) U.S. Cl. 355/72

(57) ABSTRACT

There is provided an aligner that improves contact between a glass mask and an object to be exposed. In one preferred mode, a pressure glass 3 is set at a rear side of a glass mask 1 to form a closed space 4. A pressurized air is introduced from a pressure source 5 into the closed space 4 to raise the pressure of the closed space 4 and expand the glass mask 1 toward the object to be exposed, i.e., a board 50, by which the closeness of the contact between the glass mask 1 and the board 50 improves.

### BACKGROUND OF THE INVENTION

1. Field of the Invention

The invention relates to an aligner.

2. Related Art

A photolithographic method is widely used in -many fields. In the method, a surface of an object provided with photo sensitive material such as photo resist is exposed with a certain pattern by exposing apparatus (aligner) and then the pattern is formed on the surface by etching procedure. A printed circuit board or the like is recently produced by the photolithographic method using the aligner.

The pattern to be exposed is depicted typically on a film mask made of a resin film or on a glass mask. While the film mask is cheap, it can be deformed and also its transmissivity of ultraviolet rays remarkably deteriorates by being exposed under ultraviolet rays, changing of temperature and humidity. Thus the usage of the glass mask recently increases.

When using the glass mask, is mainly utilized so-called vacuum contact method where a gap between the glass mask and the board is vacuumed in order to make close contact of them.

FIG. 7 shows the vacuum contact method. As a glass mask 98 supported by a mask holder 99 nears to a board 50, an air between the glass mask 98 and the board 50 is compressed and a compressed air layer 51 is formed. The pressure of the compressed air layer 51 swells out the glass mask 98 in the direction opposite to the board 50, which causes a gap G between the glass mask 98 and the board 50. This causes the fall of accuracy of the exposure.

In order to eliminate the gap G in the vacuum contact method, it is necessary to increase the vacuum ability between the glass mask 98 and the board 50 or to extend the vacuuming time, which lead to the delay of the procedure and high cost of the equipment.

The object of the invention is to resolve the problems.

### SUMMARY OF THE INVENTION

In the invention, the aligner comprises a glass mask depicted with a pattern to be exposed that touches an object when exposing the pattern onto the object, a body penetrative for exposing-light so positioned as to face with a gap to a non contacting surface of the glass mask that is opposite to another surface capable to contact the object, a closed space formed between the glass mask and the body, pressure means for pressurizing the closed space.

Said closed space pressurized can prevent the expansion of the glass mask toward the direction opposite to the object caused by a pressure of a compressed air layer between the glass mask and the object.

Typically a plate member is used as said body penetrating for exposing-light and preferably it is made harder to bend than the glass mask so as to effectively provide the expansion of the glass mask 1.

Said glass mask may swell toward the object by controlling said pressure of the closed space, by which the closeness of the contact between the glass mask and the object improves. Furthermore control means can be employed for controlling said pressure means so that the pressure in the closed space is gradually decreased after part of said glass mask firstly touches the object and before whole the glass mask contacts the object, by which effective close adherence between the glass mask and the object is accomplished.

### BRIEF DESCRIPTION OF THE DRAWINGS

FIG. 1 shows a schematic view of an embodiment of the invention.

FIG. 2 shows an explanatory view showing the operation of the embodiment of the invention.

FIG. 3 shows an explanatory view showing the operation of the embodiment of the invention.

FIG. 4 shows an explanatory view showing the operation of the embodiment of the invention.

FIG. 5 shows an explanatory view showing the operation of the embodiment of the invention.

FIG. 6 shows an explanatory view showing the operation of the embodiment of the invention.

FIG. 7 shows an aligner and the operations of a related art.

### DETAILED DESCRIPTION OF THE PREFERRED EMBODIMENTS

The invention will now be described in reference to attached drawings of an embodiment of an aligner using vacuum contact method.

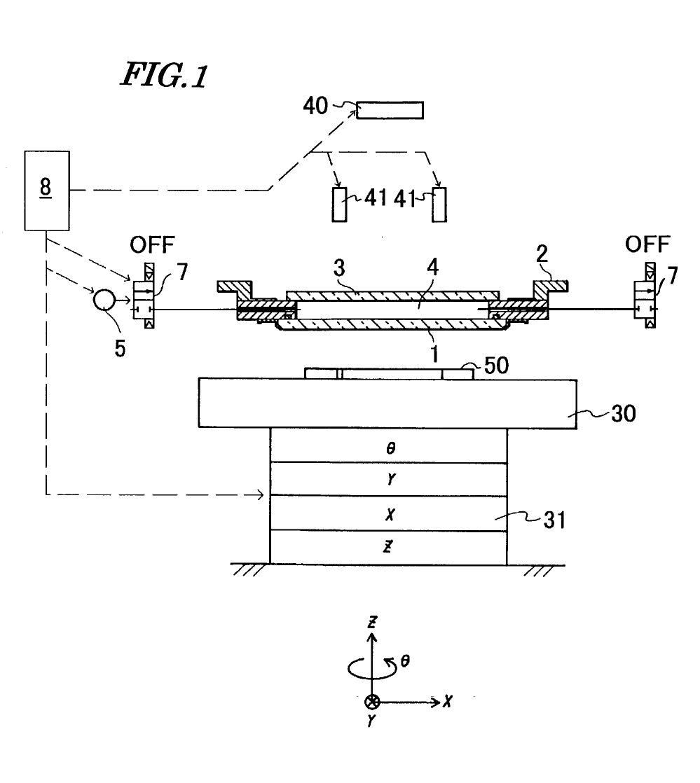

FIG. 1 shows the outline of the aligner for producing printed circuit boards, in which a board 50 provided with photo resist is laid on a platen 30 movable by a transfer device 31 in XYZ and θ direction.

A glass mask 1 depicted with a circuit pattern is positioned facing to the board 50. The glass mask 1 and the board 50 will be contacted each other and the gap between the glass mask 1 and the board 50 are sucked by vacuum equipment (not shown) in order to contact them more closely. Then the circuit patter on the glass mask 1 is exposed by an exposing light from a exposing light source 40.

A CCD camera 41 is used to adjust the positions of the glass mask 1 and the board 50.

Though the glass mask 1 and the board 50 are arranged in the vertical direction in FIG. 1, the invention is not limited to such positioning. The arrangement may be reverse or such arrangement that the glass mask 1 and the board 50 both stand up right may be utilized.

The glass mask 1 is supported at the circumference thereof by a mask holder 2 in a frame shape.

A pressure glass 3 is arranged at one side of the glass mask 1 with some gap facing a exposing light source 40, that is at the side of the glass mask 1 opposite to the board 50. The pressure glass 3 can be replaced by non-glass material that can transmit therethrough the exposing light from the exposing light source 40. The pressure glass 3 is preferably harder to bend than the glass mask 1 because the pressure glass 3 does not preferably expand by an inner pressure of a closed space 4 in order to expand the glass mask 1 by the inner pressure of the closed space 4. Therefore it is necessary to make the pressure glass 3 thick or the like.

The pressure glass 3 is also mounted on the mask holder 2 and forms said closed space 4 surrounded by the glass mask 1, the mask holder 2 and the pressure glass 3. The closed space 4 is connected to a pressure source 5 via a control valve 6 so as to be able to be pressurized. Furthermore a control valve 7 decreases the pressure of the liner of the closed space 4 to atmospheric pressure.

A controller 8 controls the pressure source 5, the control valve 6 and the control valve 7 and adjusts the inner pressure of the closed space 4 as described hereunder. The controller 8 controls the transfer device 31, a CCD camera 41 and a exposing light source 40 as well.

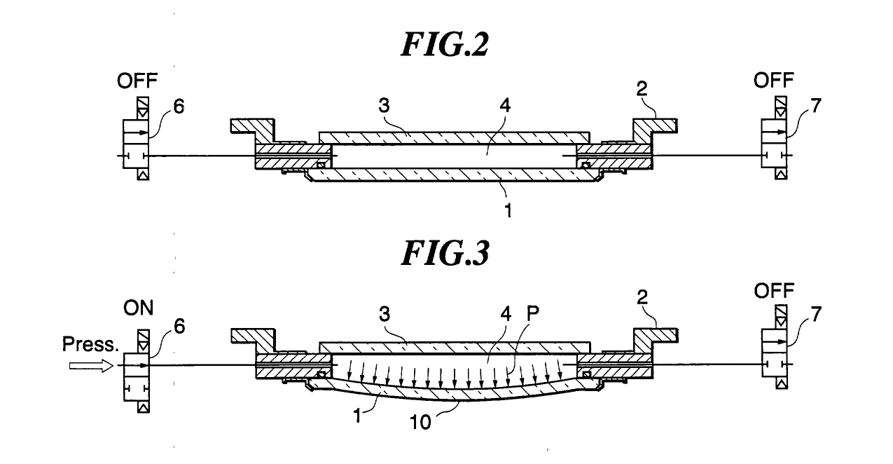

The operation will be explained referring to FIGS. 2 to 6.

FIG. 2 shows the state that the control valve 6 is off and the inner of the closed space 4 is not pressurized. Then the control valve 6 turns on and the air a little higher than atmospheric pressure starts to be introduced into the closed space 4 from the pressure source 5. FIG. 3 shows the state after having introduced the high-pressure air where the glass mask 1 expands toward the board 50 by the pressure P and a central projection 10 is formed at the center of the glass mask 1.

Simultaneously the glass mask 1 approaches to the board 50, then a compressed air layer 51 appears between the glass mask 1 and the board 50 as shown in FIG. 4. When the pressure p of the compressed air layer 51 is less than the pressure P of the closed space 4 (P>p), the central projection 10 of the glass mask 1 is kept expanded. The controller 8 controls the pressure of the closed space 4 so as to keep the condition of P>p.

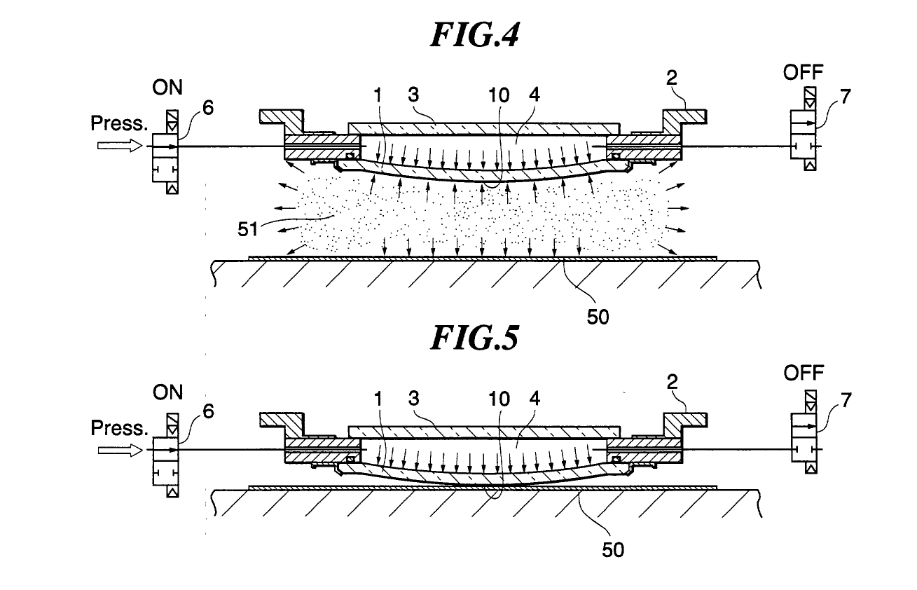

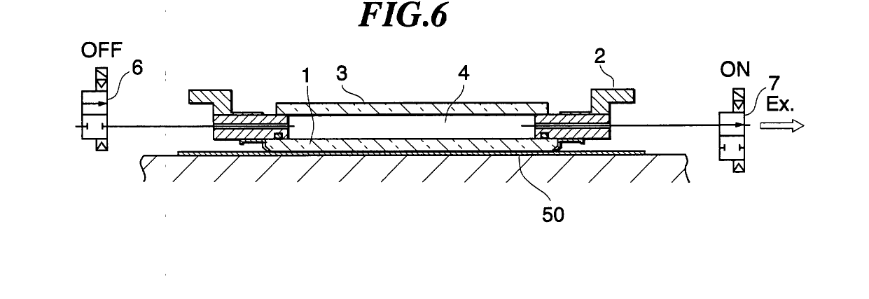

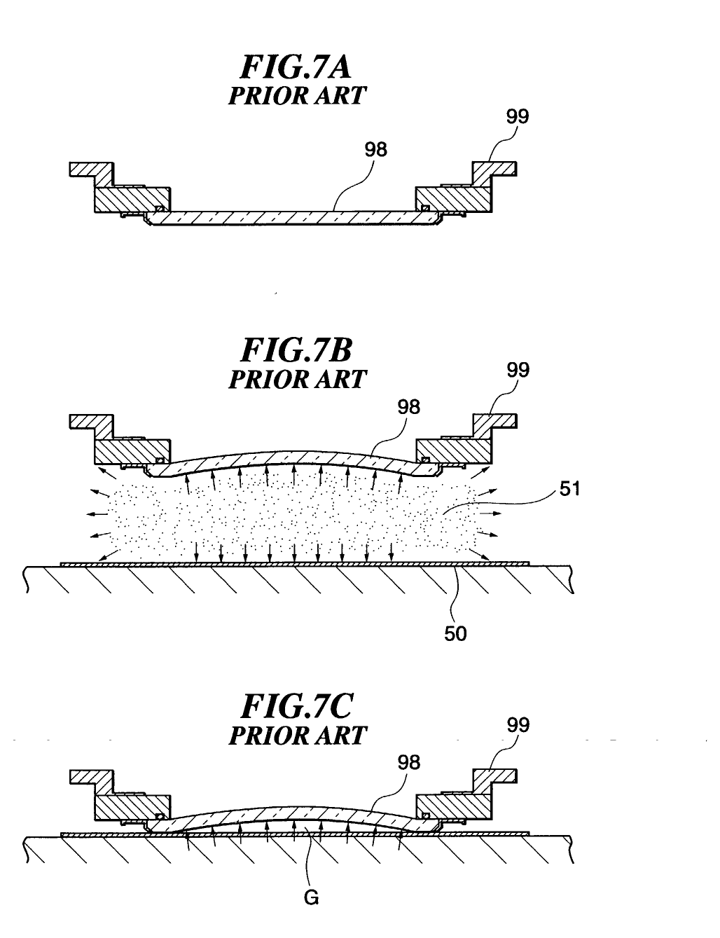

The central projection 10 at first touches the board 50 as the glass mask 1 approaches closer to the board 50 as shown in FIG. 5. Then the contact between the glass mask 1 and the board 50 gradually spread from the central projection 10 to the outskirts thereof as the pressure of the closed space 4 decreases by turning on the control valve 7 and the glass mask 1 keeps approaching to the board 50 and finally the whole of the glass mask 1 contacts the board 50 as shown FIG. 6. Thus such gap G as shown in FIG. 7 explaining the prior art, between the glass mask 98 and the board 50 does not appear. Accordingly the aligner described above accomplishes high accurate exposure.

In the case of the vacuum contact method, the glass mask 1 and board 50 closely adhere by vacuuming the space between the glass mask 1 and the board 50 by appropriate apparatus. Since the space between the glass mask 1 and the board 50 is minimum, the vacuuming provides well close adherence in a short time and vacuuming apparatus does not need much ability. The exposing by the exposing light source 40 is conducted after adhering.

As explained above, the aligner of the invention improves the closeness of the contact between the glass mask 1 and the object to be exposed and accuracy of the exposure.

What is claimed is:

1. An aligner comprising:
a glass mask depicted with a pattern to be exposed that touches an object when exposing the pattern onto the object,
a body penetrative for exposing-light so positioned as to face with a gap to a non contacting surface of the glass mask that is opposite to another surface capable to contact the object,
a closed space formed between the glass mask and the body,
pressure means for pressurizing the closed space.

2. The aligner according to claim 1, wherein said closed space is so pressurized that said glass mask may expand toward the object.

3. The aligner according to claim 1, further comprising:
control means for so controlling said pressure means that the pressure in the closed space is gradually decreased after part of said glass mask firstly touches the object and before whole the glass mask contacts the object,
wherein said glass mask expands by pressurizing said closed space and touches the object firstly at the expanded portion thereof, then whole of the glass mask gradually contacts to the object by so controlling in said controlling means the pressure of the closed space as to be gradually decreased.

4. The aligner according to claim 1,wherein said body penetrating for exposing-light is a plate and harder to bend than the glass mask.

5. An aligner comprising:
a glass mask depicted with a pattern to be exposed that touches an object when exposing the pattern onto the object,
a body penetrative for exposing-light so positioned as to face with a gap to a non contacting surface of the glass mask that is opposite to another surface capable to contact the object,
a closed space formed between the glass mask and the body,
pressure means for pressurizing the closed space,
vacuum means for vacuuming a space between the glass mask and the object when making the mask and the object in contact each other; wherein
said glass mask and the object become in contact each other as said closed space is pressurized by the pressure means and the space is vacuumed by the vacuum means.

6. The aligner according to claim 5, wherein said closed space is so pressurized that said glass mask may expand toward the object.

7. The aligner according to claim 6, further comprising:
control means for so controlling said pressure means that the pressure in the closed space is gradually decreased after part of said glass mask firstly touches the object and before whole the glass mask contacts the object,
wherein said glass mask expands by pressurizing said closed space and touches the object firstly at the expanded portion thereof, then whole of the glass mask gradually contacts to the object by so controlling in said controlling means the pressure of the closed space as to be gradually decreased.

8. The aligner according to claim 5,wherein said body penetrative for exposing-light is a plate and harder to bend than the glass mask.
